(19) United States
(12) Patent Application Publication
(10) Pub. No.: US 2022/0075069 A1
(43) Pub. Date: Mar. 10, 2022

(54) DISTANCE-MEASURING IMAGING DEVICE

(71) Applicant: Nuvoton Technology Corporation Japan, Kyoto (JP)

(72) Inventors: Seiichiro WAKU, Osaka (JP); Junichi MATSUO, Osaka (JP); Haruka TAKANO, Osaka (JP); Taichi NAGATA, Osaka (JP); Keiichi MORI, Osaka (JP); Masayuki MASUYAMA, Kyoto (JP)

(21) Appl. No.: 17/527,566

(22) Filed: Nov. 16, 2021

Related U.S. Application Data
(63) Continuation of application No. PCT/JP2020/019300, filed on May 14, 2020.
(60) Provisional application No. 62/864,112, filed on Jun. 20, 2019.

(51) Int. Cl. G01S 17/89; G01S 7/4865; G01S 7/484; G01S 7/4863

(52) U.S. Cl. CPC G01S 17/89; G01S 7/4863; G01S 7/484; G01S 7/4865

(57) ABSTRACT

A distance-measuring imaging device includes: a drive controller that outputs a light emission control signal for instructing emission of pulsed light and an exposure control signal for instructing exposure to reflected light; an image capturer that includes a plurality of pixels and outputs an exposure signal of each of the plurality of pixels that has been exposed at a timing of the exposure control signal; a pixel calculator that generates a composite signal with a pixel filter that combines exposure signals of adjacent pixels among the plurality of pixels using a weight coefficient for the exposure signal; and a time-of-flight (TOF) calculator that generates a distance image, based on the composite signal. The pixel calculator includes at least two pixel filters having different composite scale factors, and selects the pixel filter from the at least two pixel filters.

### CROSS REFERENCE TO RELATED APPLICATIONS

This is a continuation application of PCT International Application No. PCT/JP2020/019300 filed on May 14, 2020, designating the United States of America, which is based on and claims priority of U.S. Provisional Patent Application No. 62/864112 filed on Jun. 20, 2019. The entire disclosures of the above-identified applications, including the specifications, drawings and claims are incorporated herein by reference in their entirety.

### FIELD

The present disclosure relates to distance-measuring imaging devices that measure a distance to a target object.

### BACKGROUND

A conventionally known distance-measuring imaging device measures a time of flight (TOF) of pulsed light from when emitting the pulsed light to when receiving reflected light from a target object, to measure a distance to the target object. For example, Patent Literatures (PTLs) 1 to 6 each disclose a distance-measuring imaging device that generates a depth map indicating a distance using an image sensor.

### CITATION LIST

### Patent Literature

PTL 1: U.S. Patent No. 9134114

PTL 2: Japanese Unexamined Patent Application Publication No. 2013-117969

PTL 3: U.S. Pat. No. 9,784,822

PTL 4: U.S. Pat. No. 10,116,883

PTL 5: U.S. Pat. No. 10,132,626

PTL 6: U.S. Pat. No. 8,953,021

### SUMMARY

### Technical Problem

It is desirable that conventional distance-measuring imaging devices expand a distance-measuring range.

The present disclosure provides a distance-measuring imaging device capable of expanding a distance-measuring range easily.

### Solution to Problem

A distance-measuring imaging device according to one aspect of the present disclosure is a distance-measuring imaging device that emits pulsed light to a target object and receives reflected light from the target object to measure a distance to the target object, the distance-measuring imaging device including: a drive controller that outputs a light emission control signal for instructing emission of the pulsed light and an exposure control signal for instructing exposure to the reflected light; an image capturer that includes a plurality of pixels and outputs an exposure signal of each of the plurality of pixels that has been exposed at a timing of the exposure control signal; a pixel calculator that generates a composite signal using a pixel filter that combines exposure signals of adjacent pixels among the plurality of pixels using a weight coefficient for the exposure signal; and a time-of-flight (TOF) calculator that generates a distance image, based on the composite signal. The pixel calculator includes at least two pixel filters having different composite scale factors, and selects the pixel filter from the at least two pixel filters.

### Advantageous Effects

A distance-measuring imaging device according to the present disclosure is capable of expanding a distance-measuring range easily.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1A is a functional block diagram illustrating a configuration example of a distance-measuring imaging device according to an embodiment.

FIG. 1B is a diagram illustrating a detailed first configuration example of a pixel calculator according to the embodiment.

FIG. 1C is a diagram illustrating a detailed second configuration example of the pixel calculator according to the embodiment.

FIG. 1D is a diagram illustrating a detailed third configuration example of the pixel calculator according to the embodiment.

FIG. 1E is a diagram illustrating a first example of a determination table according to the embodiment.

FIG. 1F is a diagram illustrating a second example of the determination table according to the embodiment.

FIG. 1G is a diagram illustrating a third example of the determination table according to the embodiment.

FIG. 1H is a diagram illustrating a fourth example of the determination table according to the embodiment.

FIG. 1I is a diagram illustrating a fifth example of the determination table according to the embodiment.

FIG. 2 is an explanatory diagram illustrating a configuration example of frames generated by an image capturer according to the embodiment.

FIG. 3 is an explanatory diagram illustrating exposure timings according to the embodiment.

FIG. 4 is a functional block diagram illustrating another configuration example of the distance-measuring imaging device according to the embodiment.

FIG. 5 is an explanatory diagram illustrating a pixel filter function by exposure count control for each pixel according to the embodiment.

### DESCRIPTION OF EMBODIMENT

Hereinafter, a distance-measuring imaging device according to the present disclosure will be described with reference to the drawings. In this regard, however, detailed description may be omitted. For example, detailed description of well-known matter or overlapping description of substantially identical elements may be omitted. Moreover, the respective figures are not necessarily precise illustrations. These are to avoid making the subsequent description needlessly verbose, and thus facilitate understanding by a person skilled in the art.

It should be noted that the embodiment described below shows one specific example of the present disclosure. The numerical values, shapes, materials, constituent elements, the arrangement and connection of the constituent elements, etc. shown in the following embodiment are mere examples and help a person skilled in the art understand the present disclosure sufficiently, and are not intended to limit the subject matter recited in the claims.

### Embodiment

Hereinafter, a distance-measuring imaging device according to an embodiment will be described in detail with reference to the drawings.

### [Configuration Example of Distance-Measuring Imaging Device 10]

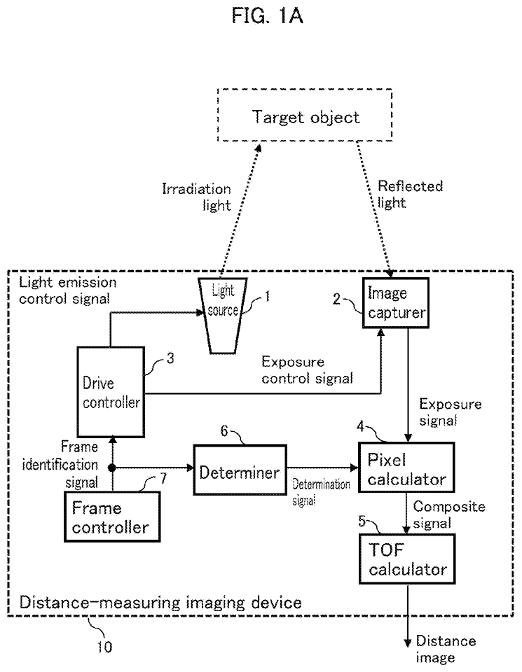

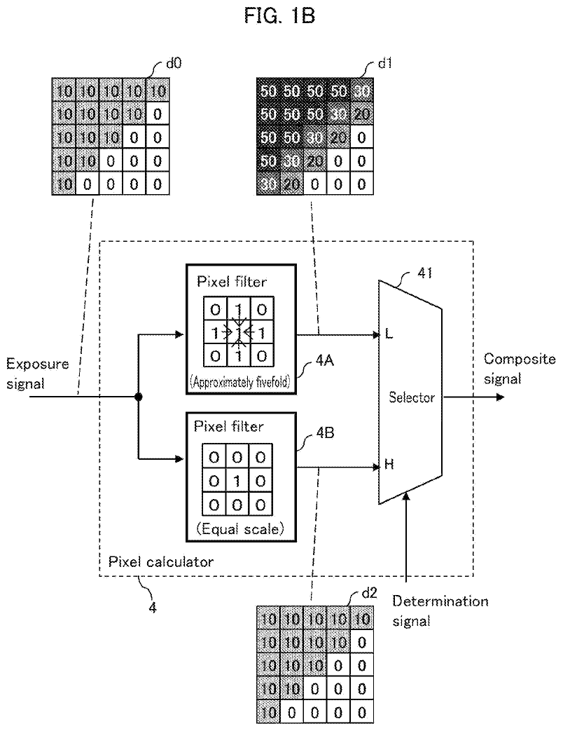

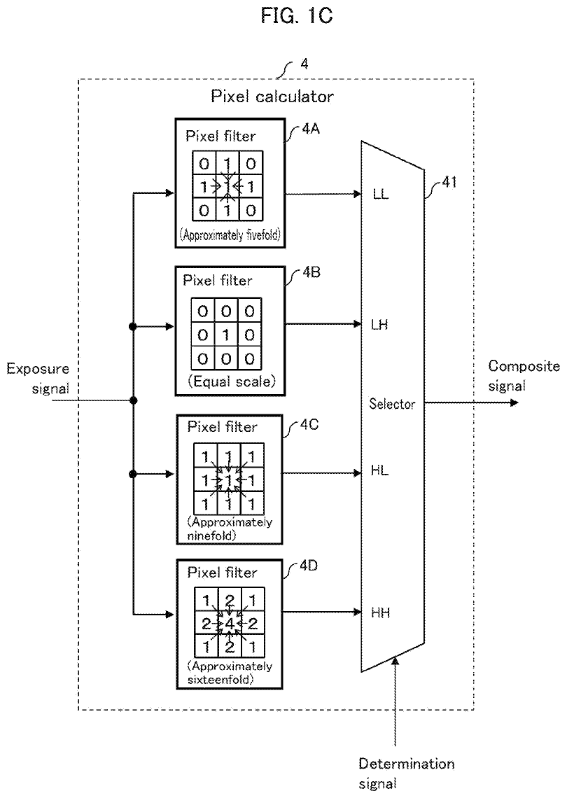

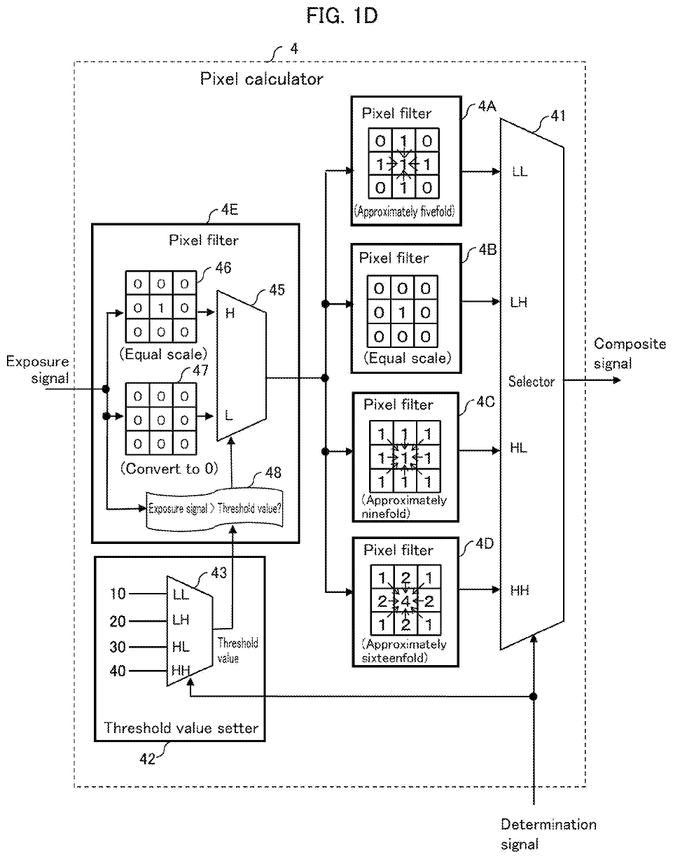

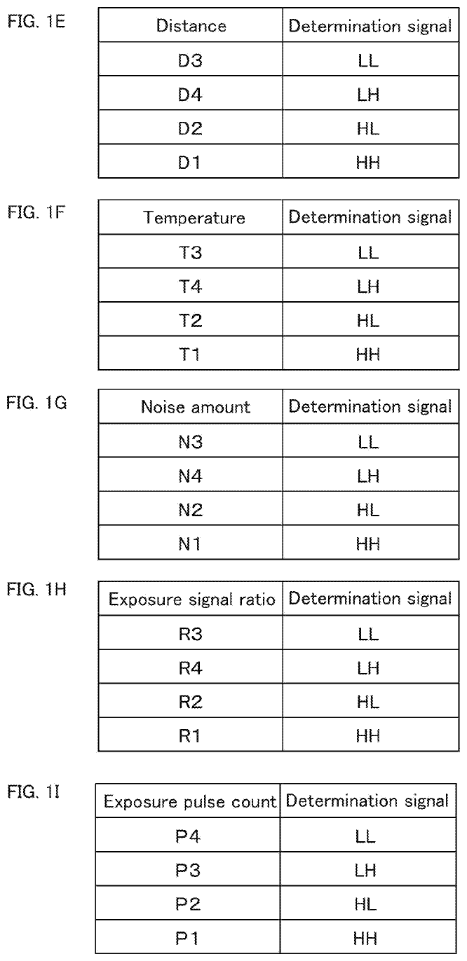

FIG. 1A is a functional block diagram illustrating a configuration example of distance-measuring imaging device 10 according to the embodiment of the present disclosure. The figure also shows a target object for distance measuring in addition to distance-measuring imaging device 10.

Distance-measuring imaging device 10 according to the embodiment of the present disclosure includes light source 1, image capturer 2, drive controller 3, pixel calculator 4, time of flight (TOF) calculator 5, determiner 6, and frame controller 7.

Light source 1 emits irradiation light (pulsed light as an example) at a timing of a light emission control signal from pixel calculator 3. Light source 1 includes, for example, light-emitting diodes that emit infrared light or laser diodes.

Image capturer 2 is an image sensor including pixels and outputs an exposure signal for each pixel exposed at a timing of an exposure control signal from pixel calculator 3. Specifically, image capturer 2 generates frames including a frame of a first type and a frame of a second type. A frame of the first type is generated based on K1 times of light emission and exposure. A frame of the second type is generated based on K2 times of light emission and exposure. Here, K1 is an integer greater than or equal to 2. In addition, K2 is an integer greater than K1. For example, K1 is approximately several tens, and K2 is approximately several hundreds. Accordingly, a frame of the first type is for a measurement of a target object in a relatively short distance. Moreover, a frame of the second type is for a measurement of a target object in a relatively long distance. It should be noted that a pixel count of image capturer 2 may conform to, for example, Video Graphics Array (VGA) of 640×480.

Drive controller 3 outputs a light emission control signal for instructing emission of pulsed light and an exposure control signal for instructing exposure to reflected light.

Pixel calculator 4 generates a composite signal through a pixel filter that combines exposure signals of adjacent pixels among the pixels using a weight coefficient for the exposure signal. Pixel calculator 4 includes at least two pixel filters each having a different composite scale factor, and selects, for example, for each frame, one of the at least two pixel filters as the pixel filter according to a determination signal from determiner 6. A pixel filter is capable of multiplying an exposure signal amount by many times using a weight coefficient value. When a target object is located far or a target object is located near but a reflectance is small, it is difficult to obtain a sufficient exposure signal amount relative to noise components such as background light. A pixel filter can be used to increase an exposure signal amount in such a case. Hereinafter, a ratio between an exposure signal amount of a pixel subjected to a pixel filter and a composite signal amount after application of the pixel filter is referred to as a composite scale factor. A composite scale factor depends on a weight coefficient of a pixel filter and ranges from zero times to tens of times.

TOF calculator 5 generates a distance image, based on the composite signal generated by pixel calculator 4.

Determiner 6 determines an image capturing environment or an image capturing use, based on at least one of an estimated distance to the target object, a temperature of image capturer 2, an amount of noise included in the exposure signal, or an operating mode, and outputs a determination signal for controlling pixel filter selection, based on a result of the determination.

Frame controller 7 generates a frame identification signal indicating a type of a frame. For example, a frame identification signal indicates whether a frame is of the first type or the second type.

Next, basic operation of distance-measuring imaging device 10 according to the present embodiment will be simply described.

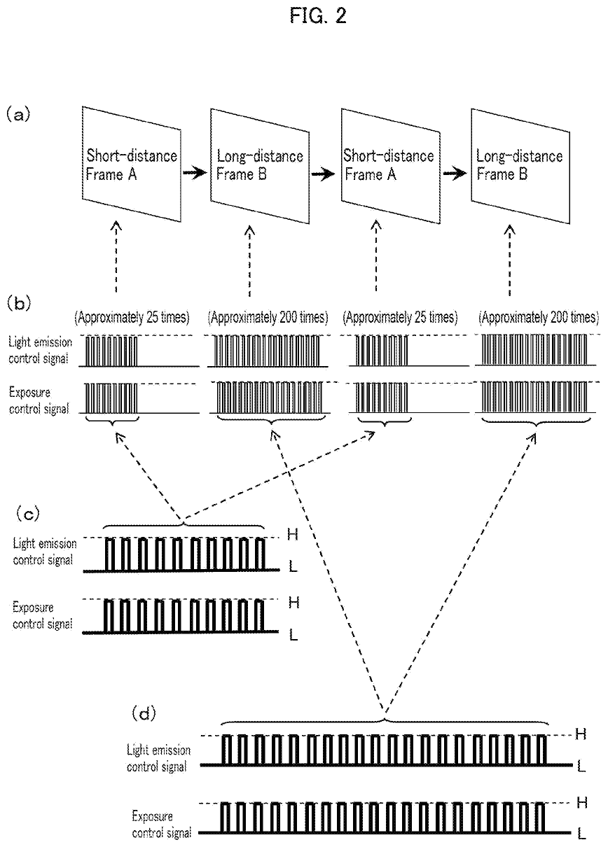

FIG. 2 is an explanatory diagram illustrating a configuration example of frames generated by image capturer 2 according to the embodiment. (a) in FIG. 2 shows time-series frames generated by image capturer 2, and short-distance frame A and long-distance frame B are alternately generated. As shown by (b) and (c) in FIG. 2, pixel calculator 3 outputs a light emission control signal and an exposure control signal. Light source 1 outputs irradiation light when the light emission control signal is H. Image capturer 2 is an area sensor having a pixel count of VGA. Image capturer 2 performs exposure to reflected light only during a period in which the light emission control signal is H, performs photoelectric conversion, and outputs, for each pixel, the sum of exposure amounts during the H period as an exposure signal, the reflected light being light obtained by the irradiation light being reflected from the target object. Short-distance frame A is equivalent to a frame of the first type when K1=25. Long-distance frame B is equivalent to a frame of the second type when K2=200.

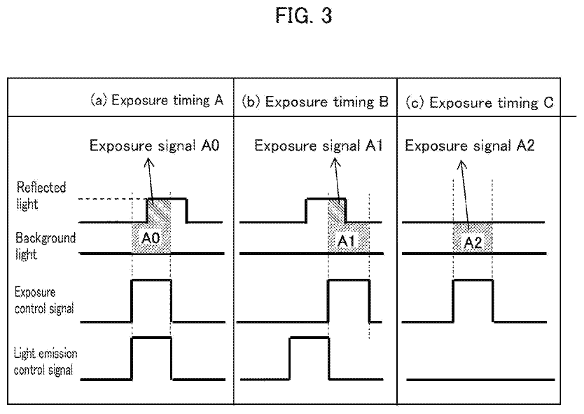

FIG. 3 is an explanatory diagram illustrating exposure timings according to the embodiment. FIG. 3 shows three types of exposure signals A0 to A2 in detail. Pulse widths of light emission control signals and pulse widths of exposure control signals at exposure timings A to C are all the same.

The light emission timing and the exposure timing are the same at exposure timing A. In other words, a light emission start timing and an exposure start timing are the same, and a light emission end timing and an exposure end timing are the same. At exposure timing B, the pulse width of the light emission control signal and the pulse width of the exposure control signal are the same, but the light emission timing and the exposure timing are different. Stated differently, a light emission end timing and an exposure start timing are the same.

Only exposure is performed without light emission at exposure timing C. As a result, exposure not to reflected light of pulsed light emitted by light source 1 but only to background light is performed.

As shown by FIG. 3, light emission and exposure are performed according to a phase relationship among the three patterns of the light emission control signals and the exposure control signals, and image capturer 2 causes each pixel to output exposure signal A0, exposure signal A1, and exposure signal A2. An exposure signal ratio shown by Equation 1 below is substantially proportional to a time of flight from when irradiation light from light source 1 is reflected from a target object to when the reflected light returns.

Exposure signal ratio=(A1−A2)/(A0+A1−2×A2) (1)

It should be noted that (b) and (c) in FIG. 2 show the exposure control signal and the light emission control signal at exposure timing A shown by FIG. 3, and the exposure control signals and the light emission control signals at timings B and C are omitted from (b) and (c) in FIG. 2.

### [First Configuration Example of Pixel Calculator 4]

FIG. 1B is a diagram illustrating a detailed first configuration example of pixel calculator 4 according to the embodiment.

As shown by the figure, pixel calculator 4 includes pixel filter 4A, pixel filter 4B, and selector 41.

The 3×3 matrix in pixel filter 4 indicates weight coefficients for the nine pixels composed of a pixel to be processed and eight pixels surrounding the pixel. The weight coefficients of, among the nine pixels, the central pixel to be processed and four pixels on the left, right, top, and bottom of the central pixel are 1. Moreover, the weight coefficients of four pixels on the upper left, upper right, lower left, and lower right of the central pixel are 0. Exposure signals of the five pixels having the weight coefficients of 1 are added with weighting and outputted as a composite signal. In this case, a composite scale factor of the composite signal for the original exposure signal amount is approximately fivefold.

On the other hand, the matrix in pixel filter 4B indicates that, among the nine pixels, only the central pixel to be processed has a weight coefficient of 1, and the remaining eight pixels have weight coefficients of 0. An exposure signal of the only pixel having the weight coefficient of 1 is directly outputted as a composite signal. In this case, a composite scale factor is one time (equal scale).

A determination signal is L (i.e., a low level) during a period for short-distance frame A shown by FIG. 2, that is, a frame of the first type; and is H (i.e., a high level) during a period for long-distance frame B shown by FIG. 2, that is, a frame of the second type. As shown by FIG. 1B, pixel calculator 4 selects pixel filter A during a period in which the determination signal outputted from determiner 6 is L, and selects pixel filter B during a period in which the determination signal is H. Exposure signals A0, A1, and A2 that image capturer 2 inputs to pixel calculator 4 are each an integrated value per one frame, that is, an integrated value of 25 times for short-distance frame A or an integrated value of 200 times for long-distance frame B. Convolution operation is performed using inputted exposure signals A0, A1, and A2 and the selected pixel filter, to output composite signals A0′, A1′, and A2′. Here, the convolution operation means adding exposure signals using weight coefficients while a pixel position is being shifted by one pixel at a time relative to all the pixels included in one frame.

Pixel group d0 shown by the figure indicates a value of exposure signal A0, A1, or A2 for 5×5 pixels in one frame. Pixel group d0 indicates, for example, an edge line of a target object in a left oblique downward direction.

Pixel group d1 indicates a pixel group after pixel group d0 is processed by pixel filter 4A. Compared to pixel group d0, pixel group d1 obtains a composite signal up to fivefold. This expands a dynamic range.

Pixel group d2 indicates a pixel group after pixel group d0 is processed by pixel filter 4B. Since pixel filter 4B directly outputs an inputted exposure signal, pixel group d2 is the same as pixel group d0.

Determiner 6 outputs L as a determination signal when a frame identification signal is L; and outputs H as a determination signal when a frame identification signal is H.

TOF calculator 5 calculates a distance from each pixel from composite signals A0′, A1′, and A2′, and outputs a distance image signal.

Frame controller 7 switches between H and L on a per image basis and outputs H or L as a frame identification signal.

Drive controller 3 sets a pulse count of a light emission control signal and an exposure control signal to approximately 25 times when a frame identification signal is L; and sets a pulse count of a light emission control signal and an exposure control signal to approximately 200 times when a frame identification signal is H.

In FIG. 1B, for example, a frame of the first type is suitable for a short-distance target object that returns relatively strong reflected light, and a frame of the second type is suitable for a long-distance target object that returns relatively weak reflected light. Even when the short-distance target object has a low reflectance, by selecting a pixel filter having a relatively large composite scale factor to an exposure signal of the frame of the first type, it is possible to expand a dynamic range and, by extension, a distance-measuring range. In addition, even when the long-distance target object has a low reflectance, by selecting a pixel filter having a relatively large composite scale factor to an exposure signal of the frame of the second type, it is possible to expand a dynamic range and, by extension, a distance-measuring range.

### [Second Configuration Example of Pixel Calculator 4]

Next, a second configuration example of pixel calculator 4 will be described.

FIG. 1C is a diagram illustrating a detailed second configuration example of pixel calculator 4 according to the embodiment. Pixel calculator 4 shown by FIG. 1C differs from pixel calculator 4 shown by FIG. 1B in that pixel filter 4C and pixel filter 4D are added, and two-input selector 41 is replaced with four-input selector 41. Hereinafter, overlapping description of the same points as FIG. 1B will be skipped, and the differences will be mainly described.

Pixel filter 4C has a composite scale factor of approximately ninefold.

Pixel filter 4D has a composite scale factor of approximately sixteenfold.

Selector 41 selects one of four pixel filters 4A to 4D according to a determination signal.

A determination signal is a two-bit signal here, and can be determined based on a combination of a frame identification signal and other factors. The other factors include a background light level, that is, a noise level. For example, a pixel filter having a larger composite scale factor may be selected when a frame is a short-distance frame of the first type and as background light is stronger.

### [Third Configuration Example of Pixel Calculator 4]

Next, a third configuration example of pixel calculator 4 will be described.

FIG. 1D is a diagram illustrating a detailed third configuration example of pixel calculator 4 according to the embodiment. Pixel calculator 4 shown by FIG. 1D differs from pixel calculator 4 shown by FIG. 1C in that pixel filter 4E and threshold value setter 42 are added. Hereinafter, overlapping description of the same points as FIG. 1C will be skipped, and the differences will be mainly described. It should be noted that pixel filter 4E is referred to as a threshold value filter.

Pixel filter 4E compares an inputted exposure signal and a threshold value; outputs zero as a composite signal when the exposure signal is less than the threshold value; and outputs the exposure signal as a composite signal when the exposure signal is greater than or equal to the threshold value.

Threshold value setter 42 determines an image capturing environment or an image capturing use, based on at least one of a temperature of image capturer 2, an amount of noise included in the exposure signal, or an operating mode; selects a threshold value according to a result of the determination; and sets the selected threshold value to pixel filter 4E. Specifically, threshold value setter 42 selects a threshold value according to a determination signal from determiner 6, and sets the selected threshold value to pixel filter 4E.

Since a threshold value is set according to an image capturing environment or an image capturing use, it is possible to set a threshold value broadly appropriate for a distance ranging from a short distance to a long distance and a target object ranging from a target object having a large reflectance to a target object having a small reflectance, and to reduce an exposure signal including a lot of noise.

### [First Example to Fifth Example of Determination Table]

Next, determination examples of determiner 6 using determination tables will be described.

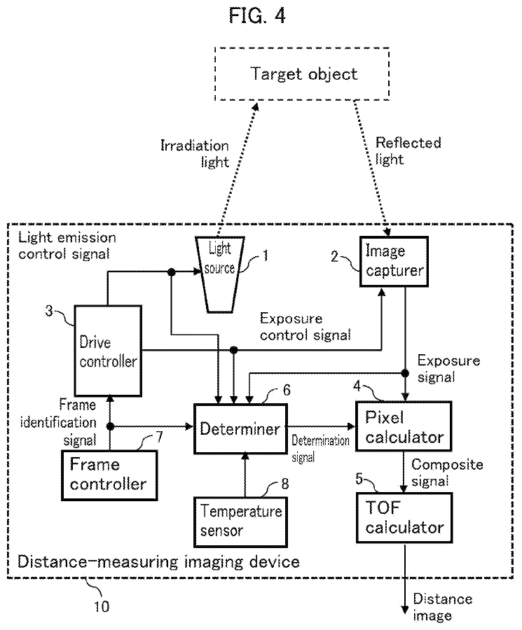

FIG. 4 is a functional block diagram illustrating another configuration example of distance-measuring imaging device 10 according to the embodiment. The figure differs from FIG. 1A in that temperature sensor 8 is added, and more information is inputted to determiner 6. Hereinafter, overlapping description of the same points as FIG. 1A will be skipped, and the differences will be mainly described.

Temperature sensor 8 measures at least one of a temperature inside distance-measuring imaging device 10 or a temperature outside distance-measuring imaging device 10, and outputs a temperature signal indicating the at least one temperature measured.

Determiner 6 receives not only a frame identification signal but also a light emission control signal, an exposure control signal, an exposure signal, and a temperature signal, compared to FIG. 1A, determines an image capturing environment or an image capturing use, based on at least one of these signals, and outputs a determination signal for controlling pixel filter selection, based on a result of the determination. For example, determiner 6 has a determination table in which values of those signals and determination signals are associated with each other, and outputs a determination signal according to the determination table.

FIG. 1E is a diagram illustrating a first example of a determination table according to the embodiment. In FIG. 1E, distances indicated by a frame identification signal and determination signals are associated with each other. For example, in the determination table shown by FIG. 1E, a shorter distance is associated with a determination signal for selecting a pixel filter having a larger composite scale factor. Distances D1 to D4 may be each a distance range or a boundary of a distance range.

A frame identification signal is, for example, a signal for identifying four types of frames including a first distance frame, a second distance frame, a third distance frame, and a fourth distance frame. In this case, the frame identification signal is also a signal indicating an operating mode determining which of the four types of the frames will be captured.

The above-described first distance frame to fourth distance frame correspond to, for example, distances in the order of shortest to longest in stated order. In this case, where exposure counts of the first distance frame to the fourth distance frame are denoted by M1 to M4, respectively, M1<M2<M3<M4 is satisfied. For example, M1, M2, M3, and M4 may be 25, 100, 200, and 400, respectively. In the determination table shown by FIG. 1E, a shorter distance is associated with a determination signal for selecting a pixel filter having a larger composite scale factor. In this case, the above-described first distance frame to fourth distance frame may be made to correspond to distances D1, D2, D4, and D3 shown by FIG. 1E, respectively.

It should be noted that “distance” may be read as “time of flight” in the determination table shown by FIG. 1E. A “time of flight” is obtained by TOF calculator 5 using Equation 1, and is equivalent to a distance to a target object in a frame actually captured. When there are target objects in a frame actually captured, a time of flight may be a “time of flight” to a target object in the center of the frame, a “time of flight” to a closest target object, or a “time of flight” to each of the target objects. Moreover, a “time of flight” obtained in a frame immediately preceding the frame may be used. In the determination table shown by FIG. 1E, a shorter time of flight is associated with a determination signal for selecting a pixel filter having a larger composite scale factor.

FIG. 1F is a diagram illustrating a second example of the determination table according to the embodiment. In FIG. 1F, temperatures indicated by a temperature signal from temperature sensor 8 and determination signals are associated with each other. Temperatures T1 to T4 may be each a temperature range or a boundary of a temperature range. In the determination table shown by FIG. 1F, a higher temperature is associated with a determination signal for selecting a pixel filter having a larger composite scale factor. A higher temperature of image capturer 2 causes a greater variation in exposure signal. Consequently, an SN ratio is degraded. The determination table shown by FIG. 1F makes it possible to reduce the degradation of the SN ratio due to temperature characteristics.

FIG. 1G is a diagram illustrating a third example of the determination table according to the embodiment. In FIG. 1G, amounts of noise in an exposure signal and determination signals are associated with each other. Amounts of noise N1 to N4 may be each a range of an amount of noise or a boundary of a range of an amount of noise. The term “amount of noise” means, for example, exposure signal A2 shown by FIG. 3, that is, background light. In the determination table shown by FIG. 1G a greater amount of noise is associated with a determination signal for selecting a pixel filter having a larger composite scale factor. A greater amount of background light causes an SN ratio between exposure signals A0 and A1 to further degrade. The determination table shown by FIG. 1G makes it possible to reduce the degradation of the SN ratio due to the background light.

FIG. 1H is a diagram illustrating a fourth example of the determination table according to the embodiment. In FIG. 1H, exposure signal ratios and determination signals are associated with each other. The term “exposure signal ratio” is a ratio shown by Equation 1, and is proportional to a “time of flight” and a “distance.” Exposure signal ratios R1 to R4 may be each a range of an exposure signal ratio or a boundary of a range of an exposure signal ratio. In the determination table shown by FIG. 1H, a smaller exposure signal ratio is associated with a determination signal for selecting a pixel filter having a larger composite scale factor.

FIG. 1I is a diagram illustrating a fifth example of the determination table according to the embodiment. In FIG. 1I, exposure pulse counts and determination signals are associated with each other. The term “exposure pulse count” means a pulse count included in an exposure control signal within a one frame period. Exposure pulse counts P1 to P4 may be each a range of an exposure pulse count or a boundary of a range of an exposure pulse count. It should be noted that a light emission pulse count may be used instead of an exposure pulse count. For example, in the determination table shown by FIG. 1I, a larger exposure pulse count is associated with a determination signal for selecting a pixel filter having a larger composite scale factor.

It should be noted that determiner 6 may use a determination table obtained by combining at least two determination tables selected from the determination tables shown by FIG. 1E to FIG. 1I.

### [Pixel Filter Function by Exposure Count Control]

Next, an example in which a pixel filter is configured not by addition with weighting but by exposure count control will be described.

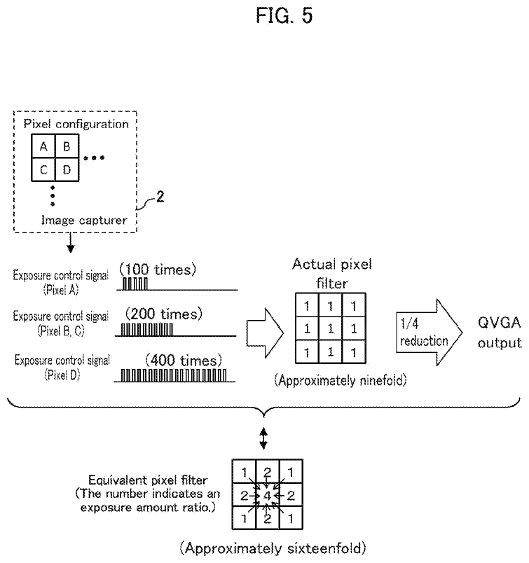

FIG. 5 is an explanatory diagram illustrating a pixel filter function by exposure count control for each pixel according to the embodiment. In the figure, pixels of image capturer 2 are composed of four-pixel arrays each including pixel A to pixel D.

In the example shown by FIG. 5, pixel A has an exposure count per frame that is controlled to 100 times. Pixel B and pixel C have an exposure count per frame that is controlled to 200 times. Pixel D has an exposure count per frame that is controlled to 400 times. In this case, exposure control signals need not be separately connected to pixel A, pixels B and C, and pixel D, and 400 exposure pulses are commonly supplied to all the pixels. Image capturer 2 discards 300 exposure signals out of 400 exposure signals of pixel A, and accumulates the remaining 100 exposure signals to generate an exposure signal for one frame. Image capturer 2 discards 200 exposure signals out of 400 exposure signals of pixel B and pixel C, and accumulates the remaining 200 exposure signals to generate an exposure signal for one frame. Likewise, image capturer 2 accumulates 400 exposure signals of pixel D without discarding the 400 exposure signals, to generate an exposure signal for one frame.

Moreover, in FIG. 5, after the exposure signals are passed through a pixel filter having a composite scale factor of approximately ninefold, the composite signal is outputted as a frame having a pixel count obtained by adding four pixels and being divided by ¼, that is, QVGA having a pixel count of 320×240.

This QVGA output is equivalent to conversion into QVGA through an equivalent pixel filter shown by the lower portion of FIG. 5.

In this way, by controlling an exposure count for each pixel, that is, controlling a discard count and an accumulation count, it is possible to allow a pixel filter equivalent to addition with weighting to function.

As stated above, distance-measuring imaging device 10 according to the embodiment of the present disclosure is distance-measuring imaging device 10 that emits pulsed light to a target object and receives reflected light from the target object to measure a distance to the target object, distance-measuring imaging device 10 including: drive controller 3 that outputs a light emission control signal and an exposure control signal; light source 1 that emits light at a timing of the light emission control signal; image capturer 2 that outputs an exposure signal obtained by performing exposure to reflected light from the target object resulting from the emitted light, at a timing of the exposure control signal; determiner 6 that outputs a determination signal; and pixel calculator 4 that performs, on the exposure signal, composition according to a pixel filter using the exposure signal as an input, and outputs the exposure signal as a composite signal. Pixel calculator 4 includes at least two pixel filters and switches between the at least two pixel filters, based on the determination signal.

Moreover, distance-measuring imaging device 10 further includes time-of-flight (TOF) calculator 5 that outputs a distance image using composite data as an input.

Furthermore, TOF calculator 5 changes a resolution of the distance image, based on a frame identification signal, and outputs the distance image.

Moreover, driver controller 3, image capturer 2, determiner 6, pixel calculator 4, and TOF calculator 5 are disposed on the same semiconductor substrate.

Furthermore, distance-measuring imaging device 10 further includes frame controller 7. Frame controller 7 outputs a frame identification signal on a per frame basis. Drive controller 3 changes a pulse count of at least one of the light emission control signal or the exposure control signal, based on the frame identification signal. Determiner 6 outputs the determination signal, based on the frame identification signal.

Moreover, distance-measuring imaging device 10 further includes temperature sensor 8. Temperature sensor 8 outputs a temperature signal, based on at least one of a temperature inside distance-measuring imaging device 10 or a temperature outside distance-measuring imaging device 10.

Furthermore, determiner 6 outputs the determination signal, based on the temperature signal.

Moreover, determiner 6 outputs the determination signal, based on a magnitude of the exposure signal.

Furthermore, determiner 6 outputs the determination signal, based on a magnitude of at least one of a pulse count of the light emission control signal or a pulse count of the exposure control signal.

Moreover, determiner 6 outputs the determination signal, based on a ratio of the exposure signal.

Accordingly, the distance-measuring imaging device according to the embodiment of the present disclosure is capable of expanding a distance-measuring range while keeping a resolution of a long-distance frame.

Moreover, the distance-measuring imaging device is capable of reducing the influence of a decrease in resolution because a short-distance target object is captured in a large size.

It should be noted that a determination signal may be controlled based on an exposure signal ratio in such a way that, where exposure signals for respective pixels and exposure timings as shown by FIG. 3 are denoted by A0, A1, and A2, a determination signal is L when (A1−A2)/(A0+A1−2×A2)<¼; and a determination signal is H when (A1−A2)/(A0+A1−2×A2)≥¼.

It should be noted that pixel calculator 4 may switch between at least three filters as shown by FIG. 1C.

It should be noted that although TOF calculator 5 outputs a distance image having VGA when a frame identification signal is H, TOF calculator 5 may output a distance image having a resolution (e.g., QVGA) lower than VGA when a frame identification signal is L.

It should be noted that the distance-measuring imaging device may be configured as shown by FIG. 4, and determiner 6 may output a determination signal, based on a result of comparison between an exposure signal amount and a determination table.

It should be noted that the distance-measuring imaging device may include temperature sensor 8, temperature sensor 8 may detect a surrounding temperature as an input and output a temperature signal, and determiner 6 may output a determination signal, based on a result of comparison between the temperature signal and a determination table.

It should be noted that, as shown by FIG. 5, image capturer 2 may be allowed to change an exposure count for each pixel and may set an exposure control count for pixel A to approximately 100 times, an exposure control count for pixels B and C to approximately 200 times, and an exposure control count for pixel D to approximately 400 times, and pixel calculator 4 may use a pixel filter based on an exposure count ratio.

As described above, distance-measuring imaging device 10 according to one aspect of the present disclosure is distance-measuring imaging device 10 that emits pulsed light to a target object and receives reflected light from the target object to measure a distance to the target object, distance-measuring imaging device 10 including: drive controller 3 that outputs a light emission control signal for instructing emission of the pulsed light and an exposure control signal for instructing exposure to the reflected light; image capturer 2 that includes a plurality of pixels and outputs an exposure signal of each of the plurality of pixels that has been exposed at a timing of the exposure control signal; pixel calculator 4 that generates a composite signal using a pixel filter that combines exposure signals of adjacent pixels among the plurality of pixels using a weight coefficient for the exposure signal; and time-of-flight (TOF) calculator 5 that generates a distance image, based on the composite signal. Pixel calculator 4 includes at least two of pixel filters 4A to 4E having different composite scale factors, and selects the pixel filter from the at least two pixel filters.

This configuration produces an advantageous effect of easily expanding a dynamic range because even when an exposure signal amount is small the exposure signal amount is increased by composition by a pixel filter. The expansion of the dynamic range means an expansion of a distance-measuring range. In addition, since a pixel filter can be selected from the at least two pixel filters, for example, the configuration produces an advantageous effect of expanding the distance-measuring range according to an image capturing environment or an image capturing use.

Here, distance-measuring imaging device 10 may further include determiner 6 that determines an image capturing environment or an image capturing use, based on at least one of an estimated distance to the target object, a temperature of the image capturer, an amount of noise included in the exposure signal, or an operating mode, and outputs a determination signal for controlling pixel filter selection, based on a result of the determination. Pixel calculator 4 may select the pixel filter, based on the determination signal.

According to this configuration, it is possible to adaptively expand a distance-measuring range because a pixel filter is selected according to an image capturing environment or an image capturing use.

Here, image capturer 2 may generate frames including a frame of a first type and a frame of a second type. The frame of the first type may be generated based on K1 times of light emission and exposure, K1 being an integer greater than or equal to 2. The frame of the second type may be generated based on K2 times of light emission and exposure, K2 being an integer greater than K1. Determiner 2 may control the pixel filter selection in the pixel calculator for each of the frames, according to whether the frame generated by the image capturer is of the first type or the second type.

According to this configuration, for example, a frame of the first type is suitable for a short-distance target object that returns relatively strong reflected light, and a frame of the second type is suitable for a long-distance target object that returns relatively weak reflected light. Even when the short-distance target object has a low reflectance, by selecting a pixel filter having a relatively large composite scale factor to an exposure signal of the frame of the first type, it is possible to expand a dynamic range and, by extension, a distance-measuring range. In addition, even when the long-distance target object has a low reflectance, by selecting a pixel filter having a relatively large composite scale factor to an exposure signal of the frame of the second type, it is possible to expand a dynamic range and, by extension, a distance-measuring range.

Here, the at least two pixel filters may include a first pixel filter and a second pixel filter. The first pixel filter may have a composite scale factor larger than a composite scale factor of the second pixel filter. Pixel calculator 4 may select the first pixel filter in response to an exposure signal included in the frame of the first type, and selects the second pixel filter in response to an exposure signal included in the frame of the second type.

According to this configuration, for example, since a first pixel filter having a large composite scale factor is applied, even when a short-distance target object has a low reflectance, it is possible to expand a dynamic range for a short-distance first frame and, by extension, a distance-measuring range.

Here, distance-measuring imaging device 10 may further include temperature sensor 8 that measures at least one of a temperature inside distance-measuring imaging device 10 or a temperature outside distance-measuring imaging device 10. Pixel calculator 4 may select the pixel filter, based on the at least one temperature.

According to this configuration, since a pixel filter is selected based on a temperature, it is possible to reduce temperature dependence of distance-measuring accuracy.

Here, pixel calculator 4 may select a pixel filter having a larger composite scale factor as the at least one temperature is higher.

According to this configuration, since a pixel filter having a larger composite scale factor is selected as a temperature is higher, it is possible to reduce the influence of a variation caused by temperature dependence.

Here, pixel calculator 4 may select the pixel filter, based on a magnitude of a noise component included in the exposure signal.

According to this configuration, since a pixel filter is selected based on, for example, noise components as background light, it is possible to reduce accuracy degradation caused by the background light.

Here, pixel calculator 4 may select a pixel filter having a larger composite scale factor as the noise component is larger in magnitude.

According to this configuration, since a pixel filter having a larger composite scale factor is selected as noise components are larger, it is possible to reduce the influence of accuracy degradation caused by the noise components.

Here, determiner 6 may determine at least one of a pulse count of the light emission control signal or a pulse count of the exposure control signal in a period of one frame, and output the determination signal for selecting a pixel filter having a composite scale factor corresponding to the pulse count determined.

According to this configuration, since a pixel filter corresponding to a pulse count is selected, it is possible to compensate excess or deficiency of an exposure signal amount dependent on a distance.

Here, pixel calculator 4 may select a pixel filter having a larger composite scale factor as the pulse count is smaller.

According to this configuration, since a pixel filter having a larger composite scale factor is selected as a pulse count is smaller, for example, it is possible to compensate deficiency of an exposure signal amount caused by a target object having a small reflectance.

Here, determiner 6 may determine a time of flight of the reflected light indicated by a ratio of the exposure signal, and output the determination signal for selecting a pixel filter based on the time of flight.

According to this configuration, since a pixel filter is selected based on a time of flight, it is possible to compensate excess or deficiency of an exposure signal amount dependent on a distance.

Here, pixel calculator 4 may select a pixel filter having a larger composite scale factor as the time of flight is shorter.

According to this configuration, since a pixel filter having a larger composite scale factor is selected as a time of flight is shorter, for example, it is possible to compensate deficiency of an exposure signal amount caused by a target object having a small reflectance.

Here, the at least two pixel filters may include a threshold value filter that compares the exposure signal and a threshold value, outputs zero as the composite signal when the exposure signal is less than the threshold value, and outputs the exposure signal as the composite signal when the exposure signal is greater than or equal to the threshold value.

According to this configuration, since a threshold value filter considers an exposure signal less than or equal to a threshold value as zero, it is possible to reduce an exposure signal including a lot of noise.

Here, distance-measuring imaging device 10 may further include threshold value setter 42 that determines an image capturing environment or an image capturing use, based on at least one of a temperature of the image capturer, an amount of noise included in the exposure signal, or an operating mode, selects a threshold value according to a result of the determination, and sets the threshold value selected to the threshold value filter.

According to this configuration, since a threshold value is set according to an image capturing environment or an image capturing use, it is possible to set a threshold value broadly appropriate for a distance ranging from a short distance to a long distance and a target object ranging from a target object having a large reflectance to a target object having a small reflectance, and to reduce an exposure signal including a lot of noise.

Here, TOF calculator 5 may reduce a resolution of the distance image corresponding to the frame of the first type.

According to this configuration, although a pixel count of a short-distance frame of the first type is decreased and the resolution is degraded, the degradation of the resolution does not matter much to a short-distance object, and it is possible to expand a dynamic range and a distance-measuring range.

Here, drive controller 3, image capturer 2, determiner 6, pixel calculator 4, and TOF calculator 5 may be disposed on a same semiconductor substrate.

According to this configuration, it is possible to downsize distance-measuring imaging device 10.

The drawings and detailed description have been provided above as the embodiment in order to illustrate the technique disclosed in the present disclosure.

Therefore, the constituent elements recited in the drawings and detailed description may include not only constituent elements essential to solving the aforementioned problem but also constituent elements not essential to solving the aforementioned problem, in order to illustrate the technique. For this reason, the recitation of these non-essential constituent elements in the accompanying drawings and detailed description should not be directly interpreted to mean that the non-essential constituent elements are essential.

It should be noted that the technique disclosed in the present disclosure is not limited to the aforementioned embodiment, and is applicable to an embodiment to which modifications, replacements, additions, omissions, etc. are appropriately made. Furthermore, forms obtained by making to the embodiment various modifications conceived by a person skilled in the art as well as forms realized by combining constituent elements in different embodiments are included within the scope of the technique in the present disclosure, provided that they do not depart from the essence of the technique disclosed in the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to a distance-measuring imaging device that measures a distance to a target object.

1. A distance-measuring imaging device that emits pulsed light to a target object and receives reflected light from the target object to measure a distance to the target object, the distance-measuring imaging device comprising:
a drive controller that outputs a light emission control signal for instructing emission of the pulsed light and an exposure control signal for instructing exposure to the reflected light;
an image capturer that includes a plurality of pixels and outputs an exposure signal of each of the plurality of pixels that has been exposed at a timing of the exposure control signal;
a pixel calculator that generates a composite signal using a pixel filter that combines exposure signals of adjacent pixels among the plurality of pixels using a weight coefficient for the exposure signal; and
a time-of-flight (TOF) calculator that generates a distance image, based on the composite signal,
wherein the pixel calculator includes at least two pixel filters having different composite scale factors, and selects the pixel filter from the at least two pixel filters.

2. The distance-measuring imaging device according to claim 1, further comprising:
a determiner that determines an image capturing environment or an image capturing use, based on at least one of an estimated distance to the target object, a temperature of the image capturer, an amount of noise included in the exposure signal, or an operating mode, and outputs a determination signal for controlling pixel filter selection, based on a result of the determination,
wherein the pixel calculator selects the pixel filter, based on the determination signal.

3. The distance-measuring imaging device according to claim 2,
wherein the image capturer generates frames including a frame of a first type and a frame of a second type,
the frame of the first type is generated based on K1 times of light emission and exposure, K1 being an integer greater than or equal to 2,
the frame of the second type is generated based on K2 times of light emission and exposure, K2 being an integer greater than K1, and
the determiner controls the pixel filter selection in the pixel calculator for each of the frames, according to whether the frame generated by the image capturer is of the first type or the second type.

4. The distance-measuring imaging device according to claim 3,
wherein the at least two pixel filters include a first pixel filter and a second pixel filter,
the first pixel filter has a composite scale factor larger than a composite scale factor of the second pixel filter, and
the pixel calculator selects the first pixel filter in response to an exposure signal included in the frame of the first type, and selects the second pixel filter in response to an exposure signal included in the frame of the second type.

5. The distance-measuring imaging device according to claim 1, further comprising:
a temperature sensor that measures at least one of a temperature inside the distance-measuring imaging device or a temperature outside the distance-measuring imaging device, wherein the pixel calculator selects the pixel filter, based on the at least one temperature.

6. The distance-measuring imaging device according to claim 5, wherein the pixel calculator selects a pixel filter having a larger composite scale factor as the at least one temperature is higher.

7. The distance-measuring imaging device according to claim 1, wherein the pixel calculator selects the pixel filter, based on a magnitude of a noise component included in the exposure signal.

8. The distance-measuring imaging device according to claim 7, wherein the pixel calculator selects a pixel filter having a larger composite scale factor as the noise component is larger in magnitude.

9. The distance-measuring imaging device according to claim 2, wherein the determiner determines at least one of a pulse count of the light emission control signal or a pulse count of the exposure control signal in a period of one frame, and outputs the determination signal for selecting a pixel filter having a composite scale factor corresponding to the pulse count determined.

10. The distance-measuring imaging device according to claim 9, wherein the pixel calculator selects a pixel filter having a larger composite scale factor as the pulse count is smaller.

11. The distance-measuring imaging device according to claim 2, wherein the determiner determines a time of flight of the reflected light indicated by a ratio of the exposure signal, and outputs the determination signal for selecting a pixel filter based on the time of flight.

12. The distance-measuring imaging device according to claim 11,
wherein the pixel calculator selects a pixel filter having a larger composite scale factor as the time of flight is shorter.

13. The distance-measuring imaging device according to claim 1,
wherein the at least two pixel filters include a threshold value filter that compares the exposure signal and a threshold value, outputs zero as the composite signal when the exposure signal is less than the threshold value, and outputs the exposure signal as the composite signal when the exposure signal is greater than or equal to the threshold value.

14. The distance-measuring imaging device according to claim 13, further comprising:
a threshold value setter that determines an image capturing environment or an image capturing use, based on at least one of a temperature of the image capturer, an amount of noise included in the exposure signal, or an operating mode, selects a threshold value according to a result of the determination, and sets the threshold value selected to the threshold value filter.

15. The distance-measuring imaging device according to claim 3,
wherein the TOF calculator reduces a resolution of the distance image corresponding to the frame of the first type.

16. The distance-measuring imaging device according to claim 2,
determiner, the pixel calculator, and the TOF calculator are disposed on a same semiconductor substrate.
